(19) United States
(12) Patent Application Publication
(10) Pub. No.: US 2004/0078452 A1
(43) Pub. Date: Apr. 22, 2004

(54) Internet browsing system

(76) Inventor: Scott Jamieson, Elizabeth Bay (AU)

Correspondence Address: Dickstein Shapiro, Morin & Oshinsky, 41st Floor, 1177 Avenue of the Americas, New York, NY, 10036-2714, US

(21) Appl. No.: 10/344,848

(22) PCT Filed: Aug. 13, 2001
(86) PCT No.: PCT/AU01/00994

(30) Foreign Application Priority Data
Aug. 17, 2000 (AU) PR2609
Nov. 13, 2000 (AU) PR1445

(51) Int. Cl. G06F 15/16; G09G 5/00

(52) U.S. Cl. 709/218; 709/219; 345/738

(57) ABSTRACT

An internet browsing system (10) is disclosed which includes means (14) for generating a first website (15) accessible by a user, and a database associated with the generating means. The database (18) is arranged to store a plurality of user accounts, each user account is arranged to store profile data associated with a user, and the profile data is accessible through the first website (15) and includes data indicative of at least one icon and for each icon data indicative of the address of a second website which has been associated with the icon by a user. Each icon associated with a second website is viewable on the first website and is selectable by a user. The arrangement is such that when an icon is selected by a user a hyperlink to the second website associated with the icon is activated.

### FIELD OF THE INVENTION

The present invention relates to an internet browsing system.

### BACKGROUND OF THE INVENTION

It is known to provide an internet browsing program which is stored and run on a personal computer. Such browsing programs generally include a storage portion which stores information indicative of website addresses previously visited by a user, for example in a form commonly known as a “favourites” file and/or a “history” file.

In use of the browsing program, in order to connect to a website, the user either selects one of the previously stored website addresses in the favourites file or history file, directly enters a website address, or connects to an internet search engine and searches for a particular website.

While such an internet browsing program operates in a satisfactory way to connect to a desired website, the browsing program suffers from a disadvantage in that the website information stored in the favourites tile or the history file is specific to the personal computer on which the program is stored. Accordingly, when a different computer is used, it is necessary for the user to either remember the address of a desired website or to use a search engine to locate the desired website.

To improve on such a program, it is known to provide an internet browsing system wherein a favourites file is stored in a database associated with a primary website. In this way, a user is able to connect to secondary websites the addresses of which are stored in the favourites file from any location by connecting to the primary website.

### SUMMARY OF THE INVENTION

In accordance with a first aspect of the present invention, there is provided an internet browsing system including:

means for generating a first website accessible by a user; and

a database associated with the first website;

the database being arranged to store a plurality of user accounts, each user account being arranged to store profile data associated with a user, the profile data being accessible through the first website and including data indicative of at least one icon and for each icon data indicative of the address of a second website which has been associated with the icon by a user, and each icon associated with a second website being viewable on the first website and being selectable by a user;

the arrangement being such that when an icon is selected by a user a hyperlink to the second website associated with the icon is activated.

In this way, the user is provided with a personalised “home page” containing icons representing the users favourite websites that is not specific to a particular personal computer. The icons on the “home page” have been associated with website addresses selected by a user and the user is able to connect to any of the website addresses associated with the icons by activating an appropriate icon, for example using a mouse.

In the present specification, it will be understood that the term “internet” means any networked communications system, including the Internet, intranets and extranets. It will also be understood that the term “icon” means any graphical identifier such as a pictorial representation or a logo. It will also be understood that the term “registered icon” means an icon which is associated with a predetermined website and which has been formally associated with the internet browsing system by the owner of the icon. It will also be understood that a “generic icon” means any icon which is not a registered icon. It will also be understood that a “website identifier” is an icon which has been associated with a website address by a user, which is displayed on the home page of the user and which functions as an activatable link to the website address associated with the icon.

In one embodiment, the database is also arranged to store separate generic icons; each generic icon being selectable by a user for association with a hyperlink to a website. In a further embodiment, the database is also arranged to store separate hyperlinks to website addresses, each hyperlink being selectable by a user for association with an icon.

Preferably, the database includes an icons file and the icons file includes a generic icons file arranged to store the generic icons. Preferably, the generic icons file includes a plurality of sub files, each sub file being arranged to store generic icons representative of a particular field of interest and/or activity.

Preferably, the icons file also includes a registered icons file arranged to store registered icons with associated hyperlinks to website addresses.

Preferably, the user accounts are also arranged to store registered icons which have been transferred to the user accounts by a user.

The registered icons file may include a plurality of sub files, each sub file being arranged to store registered icons and associated hyperlinks to website addresses specific to a particular field of interest and/or activity.

In one embodiment, the database also includes a favourites file and/or a history file arranged to store hyperlinks to website addresses selected for storage by a user and/or previously visited by a user.

In one embodiment, each user account includes a plurality of folders, each folder corresponding to a page on the primary website and each folder being arranged to store icons with associated hyperlinks to website addresses selected by the user. The internet browsing system may be arranged such that a label is assignable to each folder by a user.

Preferably, the internet browsing system is arranged to facilitate transfer of icons from the generic icons file to a user account and, in embodiments which include a registered icons file, a favourites file and a history file, to facilitate transfer of registered icons and associated hyperlinks to website addresses from the registered icons file to a user account, and/or to facilitate transfer of hyperlinks to website addresses from the favourites file, the history file to a user account.

For embodiments which facilitate storage of registered icons, the system may be arranged such that a generic icon stored in a user account is automatically replaced with a registered icon if and when the owner of a website associated with the generic icon becomes formally associated with the system.

The system may be configured so as to display information with a generic icon or registered icon, preferably when a mouse cursor locates above or adjacent the generic icon or registered icon. The information content of the displayed information may be controlled by the owner of the website associated with the generic icon or registered icon.

The system may be configured so as to operate with any internet browsing program.

Preferably, an advertising region for displaying advertising information from advertisers and/or sponsors is provided.

Preferably, the system includes a central controller for coordinating transfer of information between the website and the database.

Preferably, the database is also arranged to store demographic information and/or interest information for each user.

In accordance with a second aspect of the present invention, there is provided a method of facilitating internet browsing, said method including the steps of:

generating a first website accessible by a user;

providing a database associated with the first website, the database being arranged to store a plurality of user accounts, each user account being arranged to store profile data associated with the user, and the profile data being accessible through the first website and including data indicative of at least one icon and for each icon data indicative of the address of a second website which has been associated with the icon by a user;

displaying on the first website each icon which has been associated with a second website by a user;

facilitating selection of said displayed icons by a user; and

when an icon is selected by a user, activating a hyperlink to a second website associated with the selected icon.

In accordance with a third aspect of the present invention, there is provided a method of facilitating internet browsing, said method including the steps of:

facilitating access by a user to means for generating a first website, the first website being associated with a database arranged to store a plurality of user accounts, each user account being arranged to store profile data associated with a user, the profile data being accessible through the first website and including data indicative of at least one icon and for each icon data indicative of the address of a second website which has been associated with the icon by a user;

facilitating display on the first website of each icon which has been associated with a second website by a user; and

facilitating selection of said displayed icons by a user and thereby activation of a hyperlink to a second website associated with the selected icon.

### BRIEF DESCRIPTION OF THE DRAWINGS

An embodiment of the present invention will now be described, by way of example only, with reference to the accompanying drawings, in which:

FIG. 1 is a block diagram of an embodiment of an internet browsing system in accordance with the present invention shown in relation to a conventional internet browsing program;

FIG. 2 is a diagrammatic representation of a screen view of a home page of a website of an embodiment of an internet browsing system in accordance with the present invention;

FIG. 3 is a diagrammatic representation of a screen view of an add icon window of the website of the embodiment of FIG. 2;

FIG. 4 is a block diagram showing the structure of a database of an internet browsing system in accordance with an alternative embodiment of the present invention; and

FIGS. 5 to 7 are diagrammatic representations of window views of a website of the internet browsing system of the embodiment of FIG. 4.

### DESCRIPTION OF EMBODIMENTS OF THE INVENTION

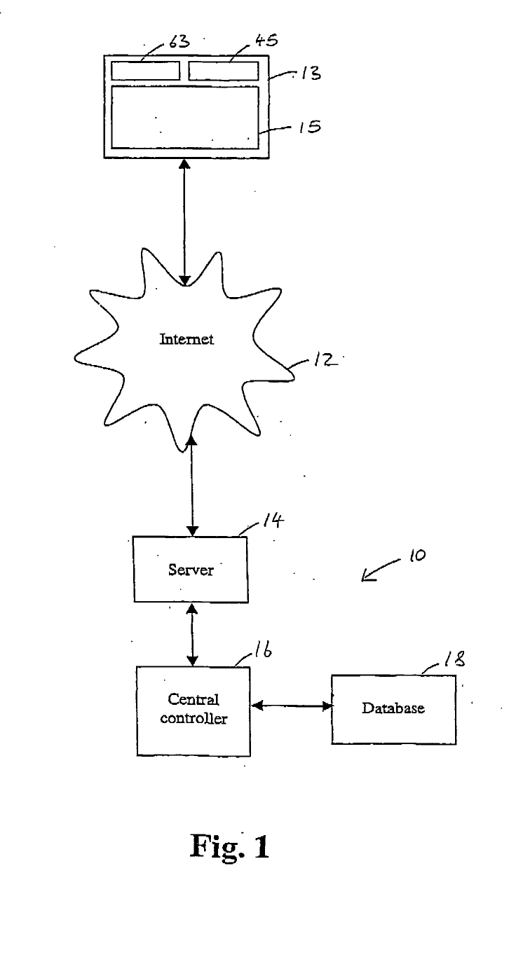

Referring to the drawings, in FIG. 1 there is shown an internet browsing system 10 shown schematically in relation to the Internet 12 and a conventional internet browsing program 13.

The internet browsing system 10 includes a server 14 which is accessible through the Internet 12 and which is arranged to generate a website 15 viewable by a user with the aid of any conventional internet browsing program 13. The internet browsing system 10 also includes a central controller 16 and a database 18.

The database 18 includes a plurality of user accounts with each user account serving to store profile data particular to a user. Such profile data includes data indicative of hyperlinks to website addresses which are of interest to the user and which have been selected for storage by the user, and data indicative of icons which have been associated with the selected website addresses by the user. The database 18 may also include personal information of the user such as the country of location, gender, age and/or employment status of the user and/or information indicative of the interests of the user.

The central controller 16 serves to coordinate the transfer of information between the server 14 and the database 18.

In a broad sense, the internet browsing system operates as a virtual Internet browser which stores hyperlinks to website addresses selected by the user in the database 18 together with icons selected by the user to associate with the hyperlinks, and which facilitates access to stored website addresses through any internet browsing program 13 located on any personal computer or internet browsing device by selecting an appropriate icon and thereby activating the hyperlink associated with the icon.

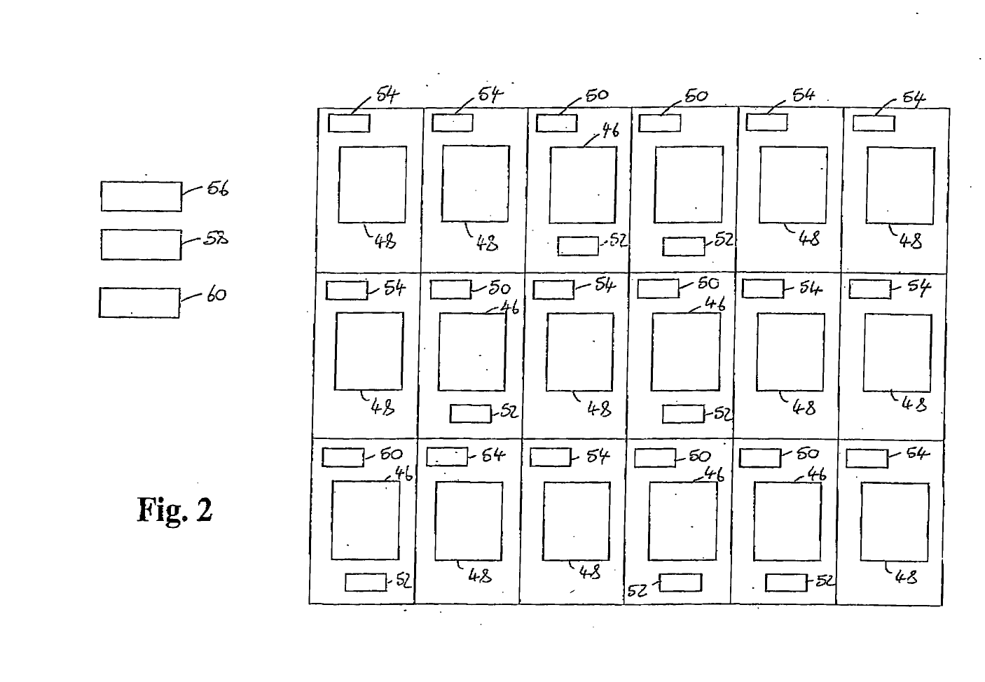

When a user connects to the server 14 using the internet browsing program 13, the website 15 is served to the user and a login screen is displayed. At this screen, the user enters a username and a password so that the user can be identified by the system 10. Following successful login, a home page 44 as shown in FIG. 2 is displayed to the user.

It will be understood that each user has an associated home page 44 which initially displays a number of available regions 48. The home page 44 serves to display to the user the icons and associated website addresses which have been stored by the user in the users account. Each available region 48 is in the form of an empty box and serves to indicate to the user that a website identifier 46 may be transferred to the available region 48 for subsequent display to the user.

The home page 44 may be populated by the user to include website identifiers 46, each of which, when activated, serves as a link to the website addresses associated with the website identifier 46.

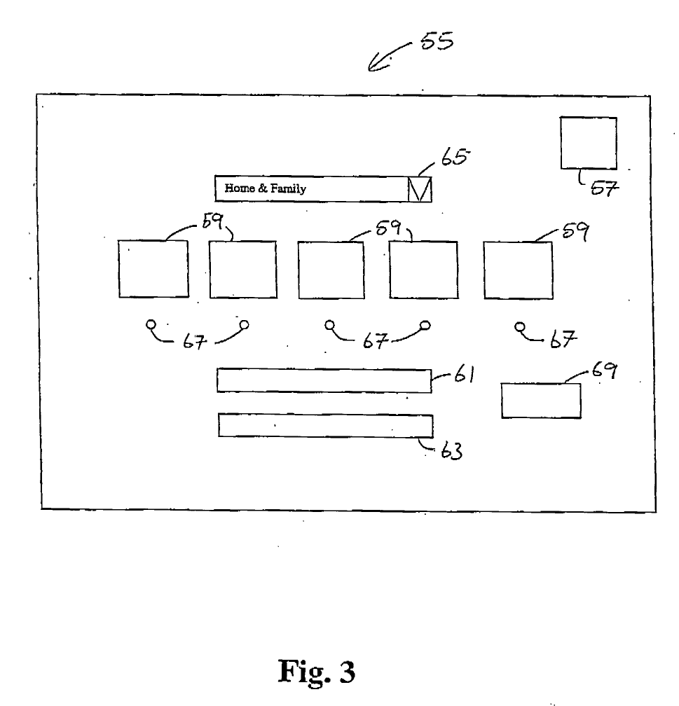

Adjacent each website identifier 46 is provided a modify button 50 which serves to allow the user to subsequently change the website identifier 46 or website address associated with the website identifier 46. Also adjacent each website identifier 46 is a site name 52 which describes the website associated with the website identifier 46 and which, when activated, also serves as a link to the website associated with the website identifier 46. Adjacent each available region 48 is provided an add icon button 54 which, when activated, displays to the user an add icon window 55 as shown in FIG. 3.

The add icon window 55 serves to facilitate selection of website addresses, icons and site names, and transferral of icons and site names to the home page 44 as website identifiers 46.

A setup facility may be included in the login screen which creates a link button 45 on the users internet browsing program, as shown in FIG. 1. Activating the link button 45 causes the add icon window 55 to be displayed. In this way, the user is able to browse the internet and to activate the link button 45 when the user wishes to transfer an icon to the users home page 44 and to associate the icon with the current website address.

Also shown on the home page 44 is a new window button 56 which, when activated, serves to open a fresh window for browsing the Internet; an add link button 58 which, when activated, serves to add a link button 63 to the internet browsing program 13, for example to a links bar of the internet browsing program 13; and an add shortcut button 60 which, when activated, serves to add a shortcut to the home page 44 to the desktop file of the users computer operating system. When the link button 63 is activated, the login screen of the website 14 is displayed or, if the user has already logged in, the users home page is displayed.

The add icon window 55 which is displayed to the user when the modify button 50 or the add icon button 54 or the link button 45 is activated by the user, includes a list of icons 59 which may be generic icons or registered icons, a website address box 61 for facilitating entry of a website address, and a site name box 63 for facilitating entry of a name which is to be associated with the entered website address and displayed to the user on the home page 44. The available generic icons and registered icons are stored in the database 18 in a generic icons file and a registered icons file respectively. The generic icons file and/or the registered icons file may include a plurality of sub files, with each sub file being for storing icons representative of a particular field of interest and/or activity. The user may select an appropriate sub file by utilising a drop down box 65 and selecting a desired icon 59 by activating the appropriate check box 67. Once the desired icon 59 has been selected and the website address and site name entered, the user activates a confirm button 69. The confirm button 69 serves to transfer a website identifier 46 representative of the entered details to the users home page 44.

The add icon window 55 may also include a home page link 57 which, when activated, causes the users home page 44 to be displayed.

It will be understood that the system 10 may be arranged such that the number and type of generic icons available for selection may be changed by the administrators of the system.

It will also be understood that with registered icons, it is not necessary to enter a website address and site name into the website address box 61 and the site name box 63, since these are entered automatically when a registered icon is selected.

In operation, the user connects to the server 14, for example by using a conventional internet browsing program 13. This may be achieved either by the user entering the address of the website 15 into the internet browsing program 13 or by activating the link button 63 on the internet browsing program 13 which has been created by the user or which has been created by a browser set up program. However, it will be understood that the browser set up program is not essential and in order for the user to connect to the website, all that the user requires is the website address of the website 15.

Once the user has connected to the server 14, the website 15 is served to the user and the user is presented with the users home page 44 as shown in FIG. 2. The user then has the option of connecting to any one of the websites which the user has previously associated with the website identifiers 46 by activating the desired website identifier 46 and associated hyperlink, or by activating the desired site name 52, for example by using the mouse. It will be understood that each of the website identifiers 46 is either a registered icon or a generic icon which has been added to the home page 44 by the user. Once the user has finished visiting the website associated with the selected website identifier 46, the user either activates the link button 63 or activates navigation buttons on the internet browsing program 13 to return to the home page 44. The user can then connect to any other website associated with the website identifiers 46 in the same way as described above by selecting another website identifier 46 and thereby activating its associated hyperlink.

To add a new website identifier 46 to the home page 44, the user has several options.

Firstly, the user may browse the internet (for example by opening a new window using the new window button 56), activate the link button 45 when a desired website has been located, and utilise the add icon window to select a generic icon and site name to be associated with the desired website.

Secondly, the user may activate an add icon button 54 associated with an available region 48 so as to display the add icon window. At the add icon window, the user is able to type in the address of the desired website, select a generic icon to be displayed on the home page 44 and associated with the desired website, and enter a site name to be associated with the website. Alternatively, instead of selecting a generic icon, the user may select a registered icon which has a default address already associated with it.

In both cases, once the user selection has been confirmed bye the user, the selected generic icon and the selected website address to be associated with the selected generic icon are stored in the users account, and the selected generic icon replaces the available region 48 on the home page 44 as a website identifier 46.

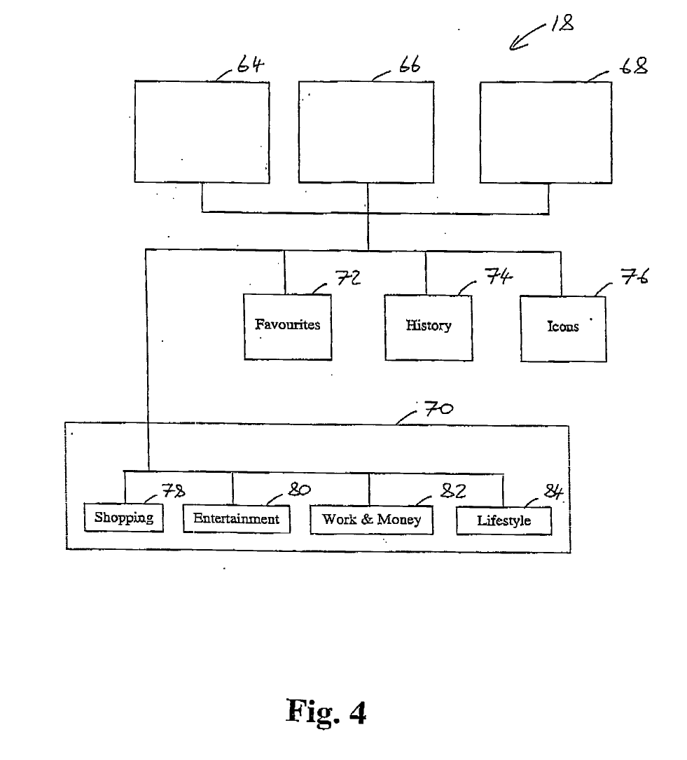

An alternative embodiment of an internet browsing system is shown in FIGS. 4 to 7.

The structure of the database 18 of the alternative embodiment is shown in FIG. 4. Each user account stored in the database 18 includes a plurality of folders 64, 66, 68 in which the user can store website identifiers. In this examples three folders are shown. However, it will be understood that any number of folders may be provided.

Website identifiers in the form of registered icons and associated hyperlinks to website addresses and/or generic icons which are to be stored in the folders 64, 66, 68 are derivable from a registered icons file 70 and a generic icons file 76. Hyperlinks to website addresses are derivable from a favourites file 72 and a history file 74.

The registered icons file 70 includes registered icons and associated hyperlinks for websites the owners of which have registered their icon with the internet browsing system. The favourites file 72 contains a list of hyperlinks to website addresses in the favourites list or bookmarks list of the users current internet browsing program. The history file 74 contains a list of hyperlinks to website addresses recently visited by the user which are contained in the history list of the users current internet browsing program. The generic icons file 76 contains a library of generic icons.

The registered icons file 70 includes four sub files, each sub file being for storing registered icons and associated hyperlinks, and each sub file being associated with a particular field of interest or activity. In this example, the sub files are a shopping file 78, an entertainment file 80, a work and money file 82, and a lifestyle file 84. However, it will be appreciated that sub files for storing registered icons and associated hyperlinks for other fields of interest or activity may also be provided.

It will be understood that the registered icons file 70 contains registered icons together with associated hyperlinks, the favourites file 72 and the history file 74 contain hyperlinks to website addresses only, and the icons file 76 contains generic icons only. The generic icons file 76 may be subdivided into icons sub files with each sub file being for storing generic icons for a particular category, field of interest or activity.

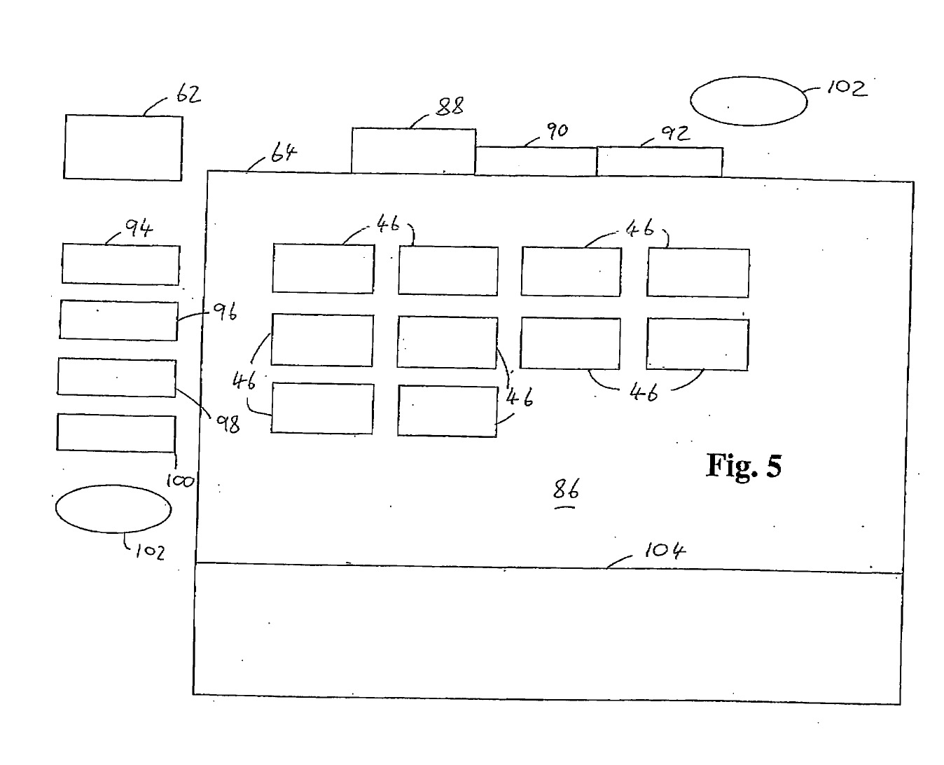

A home page 86 for this embodiment is shown in FIG. 5. As indicated by an enlarged folder navigation button 88, the first folder 64 is currently open and the website identifiers 46 contained in the first folder 64 are displayed. It will be understood that the other folders identified by the folder navigation button 90, 92 may also contain website identifiers 46. The user is able to view the desired folder by selecting the desired folder navigation button 88, 90, 92 for example by using a mouse.

Also shown on the home page 86 are category navigation buttons 94, 96, 98, 100 which correspond with the registered icons file 70, the favourites file 72, the history file 74, and the generic icons file 76. Accordingly, when the registered icons navigation button 94 is activated for example by using a mouse, the user is able to view icons in the registered icons sub files 78, 80, 82, 84. Likewise, when the favourites navigation button 96 is activated, the user is able to view the hyperlinks to website addresses in the favourites file 72, when the history navigation button 98 is activated, the user is able to view the hyperlinks to website address in the history file 74, and when the generic icons navigation button 100 is activated, the user is able to view icons in the generic icons file 76.

Also shown on the home page 86 are help buttons 102, which, when activated, for example by using the mouse, provide the user with information about the internet browsing system 10. Also shown on the homepage 86 is an advertising region 104 which may include advertising information from advertisers and/or sponsors, or messages from the operators of the internet browsing system 10.

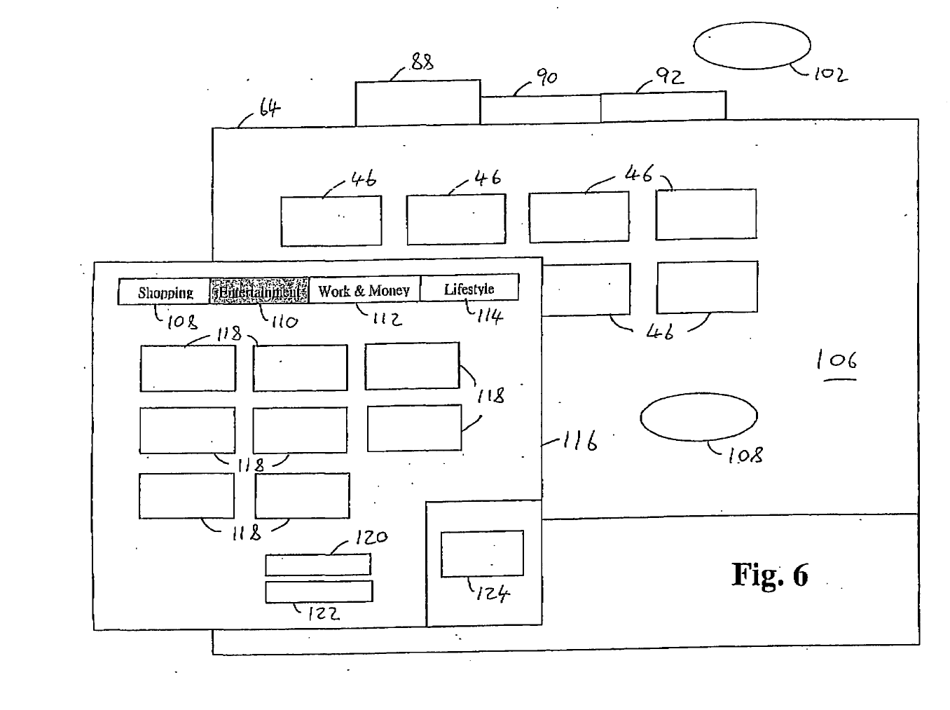

When the registered icons navigation button 94 is activated by the user, a registered icons screen 106 as shown in FIG. 6 is displayed. Like or similar features are indicated with like reference numerals.

The icons stored in the first folder 64 are still displayed. The registered icons screen 106 includes group navigation buttons 108, 110, 112, 114 corresponding to interest and/or activity groups, shopping, entertainment, work and money, and lifestyle. Also shown on the registered icons screen 106 is a back button 108 which, when activated, returns the user to the home page 86 shown in FIG. 5.

When any of the group navigation buttons is activated, the user is presented with a screen which includes registered icons associated with the activated group. For example, when the entertainment navigation button 110 is activated, an entertainment screen 116 is displayed. This screen includes entertainment related registered icons 118, each of which is associated with a website address of a company. The registered icons 118 are transferable from the entertainment group screen 116 to any one of the folders 64, 66, 68 for example by dragging and dropping the desired registered icons 118 using a mouse.

The entertainment group screen 116 also includes a link button 120 which, when activated, displays a further entertainment group screen including further entertainment registered icons 118, a search box 122 which enables a user to carry out a search for a particular registered icon on the basis of entered criteria, and new registered icons 124 which have recently become associated with the internet browsing system 10 and of which the user may not be aware.

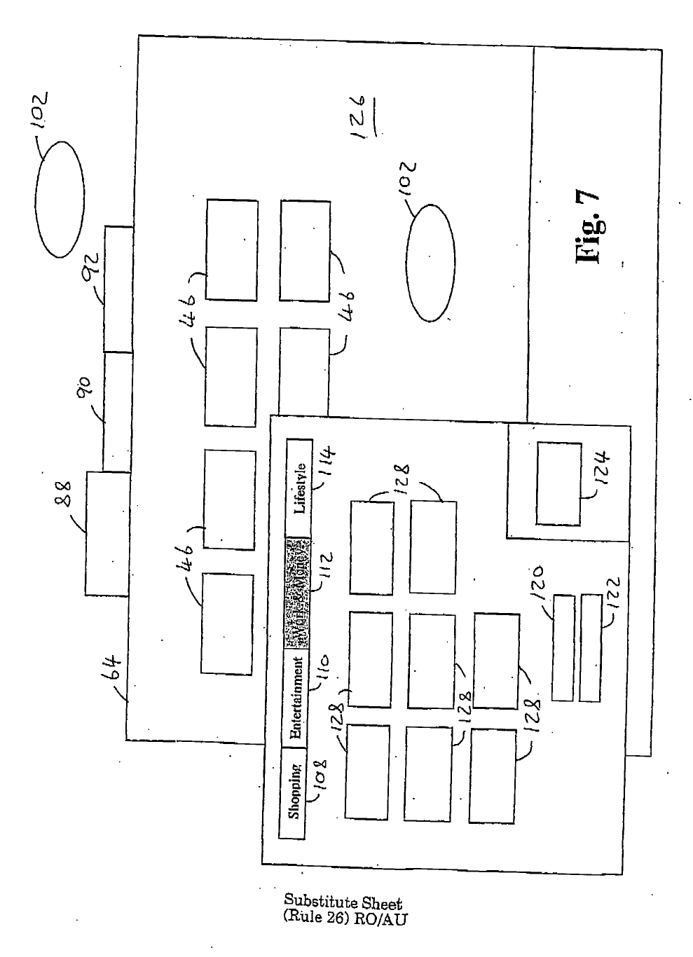

As shown in FIG. 7, when the work and money group navigation button 112 is activated, the user is presented with a work and money screen 126 which is similar to the entertainment screen 116 except that work and money registered logos 128 are displayed instead of entertainment registered logos 118. The shopping group button 108 and lifestyle group button 114 operate in a similar way in that, when activated, the user is presented with a shopping screen including registered icons associated with shopping related websites or a lifestyle screen including registered icons associated with lifestyle related websites.

To add new website identifiers 46 to the folders 64, 66, 68 the user has several options.

Firstly, the user may transfer a last visited website identifier 62 to a selected folder 64, 66, 68 for example by dragging and dropping the last visited website identifier 62 to the selected folder 64, 66, 68.

Secondly, the user may select registered icons from the registered icons sub files 78, 80, 82, 84 and transfer the selected icons to the selected folder 64, 66, 68 for example by dragging and dropping the selected icons.

Thirdly, the user may select hyperlinks to website addresses from either the favorites list or the history list from the favourites file 72 or the history file 74 respectively, and transfer the selected hyperlinks to the selected folder 64, 66, 68. It will be understood that with the third option, since no icon is associated with the hyperlinks in the favourites or history files 72, 74, when the selected hyperlinks are transferred to the selected folder, a default icon is generated for each transferred hyperlink. To change an icon and associate a hyperlink with a different desired icon, the user may select an appropriate icon from the generic icons file 76. The generic icons file 76 may be configured to automatically open when a hyperlink from the favourites file 72 or the history file 74 is transferred to a folder. The user is also able to rename the icons.

It will be appreciated that the internet browsing system 10 may be configured so as to operate with any internet browsing program 13.

It will also be appreciated that the internet browsing system 10 may be arranged such that a generic icon stored in a folder is automatically replaced with a registered icon if registration occurs after the generic icon is stored in the database 18.

It will also be appreciated that the demographic information and user interests information stored in the user accounts may be used to order the sequence of appearance of registered icons in the users registered icons file 70.

The Internet browsing system 10 may also be configured so as to display information with each registered icon, for example when a mouse cursor is located on or adjacent the registered icon. The information content may be controlled by the website owners associated with the registered icons, and may be modified either by the operators of the system 10 or by facilitating access to the database 18 by the website owners.

Furthermore, it will be appreciated that the internet browsing system may include means for facilitating creation by a user of icons for association with hyperlinks.

Modifications and variations as would be apparent to a skilled addressee are deemed to be within the scope of the present invention.

The claims defining the invention are as follows:

1. An internet browsing system including:
means for generating a first website accessible by a user; and
a database associated with the first website;
the database being arranged to store a plurality of user accounts, each user account being arranged to store profile data associated with a user, the profile data being accessible through the first website and including data indicative of at least one icon and for each icon data indicative of the address of a second website which has been associated with the icon by a user, and each icon associated with a second website being viewable on the first website and being selectable by a user;
the arrangement being such that when an icon is selected by a user a hyperlink to the second website associated with the icon is activated.

2. A system as claimed in claim 1, wherein each user account is associated with a home page viewable on the first website.

3. A system as claimed in claim 1 or claim 2, wherein the database is arranged to store generic icons, each generic icon being selectable by a user for association with a hyperlink to a website.

4. A system as claimed in any one of claims 1 to 3, wherein the database includes an icons file and the icons file includes a generic icons file arranged to store generic icons.

5. A system as claimed in claim 4, wherein the generic icons file includes a plurality of sub files, each sub file being arranged to store generic icons representative of a particular field of interest and/or activity.

6. A system as claimed in claim 4 or claim 5, wherein the icons file includes a registered icons file arranged to store registered icons with associated hyperlinks to website addresses.

7. A system as claimed in claim 6, wherein the system is arranged such that a generic icon stored in a user account is automatically replaced with a registered icon when the owner of the website associated with the generic icon becomes associated with the system.

8. A system as claimed in any one of the preceding claims, wherein the database is arranged to store hyperlinks to website addresses, each said hyperlink being selectable by a user for association with an icon.

9. A system as claimed in any one of the preceding claims, wherein the user accounts are arranged to store registered icons which have been transferred to the user accounts by a user.

10. A system as claimed in any one of the preceding claims, wherein each user account includes a folder arranged to store icons with associated hyperlinks to website addresses, the folder corresponding to a window which is viewable on the users home page.

11. A system as claimed in claim 10, wherein each user account includes a plurality of folders, each folder corresponding to a window viewable on the users home page.

12. A system as claimed in claim 10 or claim 11, wherein the system is arranged such that a label is assignable to each folder by a user.

13. A system as claimed in any one of the preceding claims, wherein the system is configured so as to display information with an icon when a cursor locates above or adjacent the icon.

14. A system as claimed in claim 13, wherein when the icon is a registered icon, the information content of the displayed information is controlled by the owner of the website associated with registered icon.

15. A system as claimed in any one of the preceding claim, further including an advertising region for displaying advertising information from advertisers and/or sponsors.

16. A system as claimed in any one of the preceding claims, wherein the database is arranged to store demographic information and/or interest information for each user.

17. A method of facilitating internet browsing, said method including the steps of;
generating a first website accessible by a user;
providing a database associated with the first website, the database being arranged to store a plurality of user accounts, each user account being arranged to store profile data associated with the user, and the profile data being accessible through the first website and including data indicative of at least one icon and for each icon data indicative of the address of a second website which has been associated with the icon by a user;
displaying on the first website each icon which has been associated with a second website by a user;
facilitating selection of said displayed icons by a user; and
when an icon is selected by a user, activating a hyperlink to a second website associated with the selected icon.

18. A method as claimed in claim 17, further including the step of associating each user account with a home page viewable on the first website.

19. A method as claimed in claim 17 or claim 18, further including the steps of storing generic icons and facilitating selection of a generic icon by a user for association with a hyperlink to a second website address.

20. A method as claimed in any one of claims 17 to 19, wherein the database includes an icons file, the icons file includes a generic icons file arranged to store generic icons.

21. A method as claimed in claim 20, wherein the generic icons file includes a plurality of sub files, each sub file being arranged to store generic icons representative of a particular field of interest and/or activity.

22. A method as claimed in claim 20 or claim 21, wherein the icons file includes a registered icons file arranged to store registered icons with associated hyperlinks to website addresses.

23. A method as claimed in any one of claims 17 to 22, further including the step of automatically replacing a generic icon stored in a user account with a registered icon when the owner of the website associated with the generic icon becomes associated with the system.

24. A method as claimed in any one of claims 17 to 23, further including the step of storing hyperlinks to website addresses in the database, each said hyperlink being selectable by a user for association with an icon.

25. A method as claimed in any one of claims 17 to 24, further including the step of arranging the user accounts to store registered icons which have been transferred to the user accounts by a user.

26. A method as claimed in any one of claims 17 to 25, further including the step of providing each user account with at least one folder arranged to store icons with associated hyperlinks to website addresses, each folder corresponding to a window which is viewable on the users home page.

27. A method as claimed in claim 26, further including the step of facilitating selection of a label assignable to each folder by a user.

28. A method as claimed in any one of claims 17 to 27, further including the step of displaying information with an icon when a cursor locates above or adjacent the icon.

29. A method as claimed in claim 28, wherein when the icon is a registered icon, the information content of the displayed information is controlled by the owner of the website associated with registered icon.

30. A method as claimed in any one of claims 17 to 27, further including the step of providing an advertising region for displaying advertising information from advertisers and/or sponsors.

31. A method as claimed in any one of claims 17 to 30, further including the step of storing demographic information and/or interest information for each user in the database.

32. A method of facilitating internet browsing, said method including the steps of:
facilitating access by a user to means for generating a first website, the first website being associated with a database arranged to store a plurality of user accounts, each user account being arranged to store profile data associated with a user, the profile data being accessible through the first website and including data indicative of at least one icon and for each icon data indicative of the address of a second website which has been associated with the icon by a user;
facilitating display on the first website of each icon which has been associated with a second website by a user; and
facilitating selection of said displayed icons by a user and thereby activation of a hyperlink to a second website associated with the selected icon.
